(19) United States
(12) Patent Application Publication
(10) Pub. No.: US 2026/0192605 A1
(43) Pub. Date: Jul. 9, 2026

(54) Tire for a Heavy Goods Vehicle with a Tread Having Improved Sturdiness

(71) Applicant: COMPAGNIE GENERALE DES ETABLISSEMENTS MICHELIN, Clermont-Ferrand (FR)

(72) Inventor: Nicolas HEROLD, Clermont-Ferrand Cedex 9 (FR)

(21) Appl. No.: 19/130,728

(22) PCT Filed: Nov. 23, 2023
(86) PCT No.: PCT/EP2023/082814

§ 371 Date: May 16, 2025

(30) Foreign Application Priority Data
Nov. 30, 2022 (FR) FR2212532

(51) Int. Cl. B60C 11/12; B60C 11/03

(52) U.S. Cl. CPC B60C 11/1236; B60C 11/0302; B60C 2200/06

(57) ABSTRACT

A tire for a heavy-duty vehicle, with an improved tread robustness having at least two complex cuts, each having an alternation of external cavities and narrowings. For any sipe joining together two external cavities that respectively belong to two adjacent complex cuts, the distance (D) between each point of intersection (I1, I2) of the sipe with each external cavity and a plane (P) bisecting the external cavity is at least equal to 25% and at most equal to 50% of the length (Le) of the external cavity, the first point of intersection (I1) with an external cavity of the first complex cut positioned in the vicinity of the leading end (E1) of the external cavity, and the second point of intersection (I2) with the external cavity of the second complex cut is positioned in the vicinity of the trailing end (E2) of the external cavity.

The present invention relates to a tire for a heavy-duty vehicle, intended to be driven on tarmacked roadways, and relates more particularly to the tread of said tire.

A tread, situated at the periphery of the tire and intended to wear down when it comes into contact with the ground via a tread surface, is made up of at least one rubber-based material. It generally comprises a tread pattern, which is a combination of cuts, or voids, and raised elements and is intended in particular to ensure a satisfactory performance in terms of grip, more particularly on a wet roadway.

As is known, the wet-weather running conditions of a vehicle, and more particularly those of a heavy-duty vehicle, require rapid evacuation of the water present in the contact patch between the tread of the tire and the roadway. This evacuation makes it possible to ensure that the material making up the tread comes into direct contact with this roadway via the tread surface. The water that is not pushed ahead of or to the sides of the tire flows or is collected partially in the cuts formed in the tread.

The evacuation of the water is ensured by the cuts, which form a fluid flow network that needs to be preferably durable, that is to say effective throughout the service life of the tire, from new to its state of maximum wear. The state of maximum wear, which is set by the regulations in force, is the state beyond which the tire needs to be removed from the vehicle for safety reasons.

The tires for heavy-duty vehicles generally have an available void volume in the contact patch which is relatively high when the tire is new. The available void volume is understood to be a void volume that is able to be filled with the water present on the roadway. The volume of voids opening onto the tread surface is evaluated when the tire is subjected to recommended inflation and load conditions as are defined in particular by the European standards of the “European Tire and Rim Technical Organization” or “ETRTO” in its “Standards Manual 2022—Commercial Vehicle Tires”.

Among the cuts, a distinction is made between sipes and grooves. The sipes have a width such that the facing walls of material that delimit them come into contact with one another at least partially when the tread enters the contact patch, under the tire load and pressure conditions specified by the ETRTO: thereby limiting the deformations of the facing portions of material and therefore wear. By contrast, the grooves, which are wider than the sipes, delimit portions of material that can deform without coming into contact with one another when the tread enters the contact patch. These deformations of the portions of material, in compression and in shear, contribute to an increase in the wearing of the tread. Moreover, when grooves are present, an increase in the deformations generates an increase in hysteresis losses of the tread, and therefore in the rolling resistance and, consequently, greater fuel consumption.

To limit the reduction in the volume of material of the tread that results from the presence of grooves, so-called complex cuts have been proposed, which make it possible, compared with normal grooves, which open entirely onto the tread surface, to increase the volume of tread material while complying with the void volume for storage of water above a given threshold, regardless of the level of wear of the tire.

Treads comprising such complex cuts have been described in particular in the documents WO 2011039194 A1, WO 2011101495 A1, WO 2012130735 A1 and WO 2020030667 A1. A complex cut opens onto the tread surface in a discontinuous manner, at a regular or irregular spacing, when new. Each complex cut has external cavities, which open onto the tread surface and are separated from one another in the main direction of the complex cut. The main direction of the complex cut corresponds to the direction in which water flows in said cut when running on ground covered in water. This complex cut comprises, besides the external cavities, internal cavities that are formed inside the tread and are generally connected to the tread surface by sipes. These internal cavities are positioned radially and entirely on the inside of the tread surface when new, and are interposed between the external cavities. The internal cavities may be positioned at different depth levels in the thickness of the tread. Moreover, the continuity of the flow of water, or more generally of fluid, in each complex cut when new is ensured by the connection between the respectively external and internal cavities. The connections between the internal and external cavities thus form a continuous groove, independently of the local orientation of the internal or external cavities. By contrast, the juxtaposition of internal and external cavities that are not connected to each other and therefore do not allow fluid to flow from one to the other around the entire circumference of the tire does not constitute a continuous groove.

For a tread having complex cuts, the volume of all of the cavities, internal and external, is reduced compared with that of grooves that open entirely onto the tread surface when new and have a depth corresponding to the maximum depth of the internal or external cavities. The presence of complex cuts thus makes it possible to limit the reduction in stiffness of the tread when new that is associated with the presence of the grooves.

A tread pattern may have both complex cuts, which open intermittently onto the tread surface, and conventional grooves, which open onto the tread surface along their entire length.

However, it has been found that the mere presence of complex cuts did not make it possible to achieve the level of grip under traction and under braking that is required on certain heavy-duty vehicles and that it was sensible to combine these complex cuts with oblique sipes, that is to say sipes inclined with respect to the main direction of the grooves, opening onto the tread surface when new. These oblique sipes generate, in the tread surface, an additional length of edge corners, making it possible to achieve a good level of traction and satisfactory grip under so-called “slippery” conditions, in particular on ground covered in water.

Nevertheless, the presence of sipes weakens the tread, and may result in the chunking of pieces of rubber and have a detrimental effect on performance in terms of grip and wear.

The damage of the tread generally starts with the initiation of cracks in the material, resulting either in the breaking stress or the fatigue limit of the material being exceeded. In both cases, the preferred regions of crack initiation are those in which stresses are concentrated, corresponding to a local geometry characterized by small radii of curvature or angles having a small angular opening. This is particularly the case for a sipe, the small thickness of which, typically at most equal to 2 mm, means that it has a small radius of curvature at its base, and the connection of which to the complex cut, to which it is connected, is usually at an inclination angle, with respect to the main direction of said main cut, with a small angular opening, for the purpose of optimization with regard to the noise generated.

Usually, the problem of crack initiation is encountered in two situations: during the manufacture of the tire, while it is being demoulded at the end of curing, or during the use of the tire.

During the demoulding of the tire, at the end of curing, the tread pattern elements that are difficult to demould, in particular the hidden internal cavities of the complex cuts, exert radial traction on the tread, and this can result, in the regions in which stresses are concentrated, in stresses that may exceed the breaking stress of the material. The difficulty of demoulding and the associated risk of chunking increase with the number and the width of the hidden internal cavities.

While the tire is being used, running over blunt objects may also result in the breaking stress of the material being exceeded. Moreover, repeated drift stresses or torque transmission stresses may, for their part, result in the fatigue limit being exceeded over time.

A person skilled in the art is familiar with adding, at the base of a sipe, a small cavity having a sufficient radius of curvature to achieve stresses, at the base of the sipe, that are lower than the breaking stress, thereby avoiding the initiation of cracks. On the other hand, the tread has lower stiffness, with a risk of a reduction in the performance in terms of wear, the demoulding of the tread is more complex, and the cost of producing the mould parts for moulding the tread is higher.

Other risks have been identified by those skilled in the art, relating to the combination of complex cuts and sipes opening into the external cavities of said complex cuts. In particular, the relative disposition of the external cavities between a plurality of complex cuts and that of the oblique sipes are likely to generate additional noise phenomena and/or to introduce uneven wearing of the tread.

In addition to the drawbacks associated with the presence of oblique sipes opening into complex cuts, as described above, those skilled in the art have also found that the presence of complex cuts in the tread increases the risk of stones being captured and trapped in the external cavities of said complex cuts, these likewise being likely to generate cracks in the tread.

Thus, the inventors set themselves the object of improving the resistance to cracking and to chunking of a tread comprising a combination of complex cuts and sipes connecting them, while limiting the generating of noise and ensuring a satisfactory compromise between the performance in terms of wear, in terms of grip and in terms of rolling resistance, respectively.

This object has been achieved by a tire for a heavy-duty vehicle, comprising a tread that is intended to come into contact with the ground via a tread surface and comprises cuts delimiting raised elements,
the tread having a thickness, measured perpendicularly to the tread surface, that is equal to the depth of the deepest cut,
the tread comprising at least two adjacent complex cuts, each comprising, when the tire is new, an alternation of external cavities and narrowings,
each external cavity having a length, measured at the tread surface, between a leading end, intended to come into contact with the ground first, in the running direction of the tire, and a trailing end, intended to come into contact with the ground last, the leading end and trailing end being positioned on a mean line of the external cavity,
the external cavity having a width, measured perpendicularly to the mean line of the external cavity, the maximum value of which is at least equal to 6 mm, and having a height, measured perpendicularly to the tread surface,
each narrowing having a width, measured perpendicularly to a mean line of the narrowing, at most equal to the width of the external cavity and at most equal to 2 mm, and having a height, measured perpendicularly to the tread surface,
the narrowing being continued radially inwards by an internal cavity, having a width, measured perpendicularly to a mean line of the internal cavity, and having a height, measured perpendicularly to the tread surface,
at least one sipe, extending from a first point of intersection with an external cavity of a first complex cut to a second point of intersection with the closest external cavity of a second complex cut adjacent to the first complex cut,
the sipe having a width, measured perpendicularly to a mean line of the sipe, at most equal to 2 mm, and having a height, measured perpendicularly to the tread surface,
the distance between each point of intersection of the sipe with each external cavity and a plane bisecting the external cavity, perpendicular to the mean line of the external cavity and equidistant from the leading end and trailing end of the external cavity, being at least equal to 25% and at most equal to 50% of the length of the external cavity,
the first point of intersection of the sipe with an external cavity of the first complex cut being positioned in the vicinity of the leading end of said external cavity,
the second point of intersection of the sipe with the closest external cavity of the second complex cut being positioned in the vicinity of the trailing end of said external cavity.

The invention is characterized essentially by the position of the sipes connecting the external cavities that are closest to each other of two adjacent complex cuts being optimized.

According to a first essential feature, the distance between each point of intersection of the sipe with each external cavity and a plane bisecting the external cavity, perpendicular to the mean line of the external cavity and equidistant from the leading end and trailing end of the external cavity, is at least equal to 25% and at most equal to 50% of the length of the external cavity. In other words, the sipe opens into an external cavity and not into a narrowing zone continued radially inwards by an internal cavity.

While the tire is being manufactured, and, more particularly, at the end of its curing step in a mould, this position of the sipe has the advantage of avoiding the occurrence of cracks at the base of said sipe, when the closest internal cavity is demoulded. When the tire is running, this position of the sipe encourages the ejection of potentially stuck stones, at one end of the external cavity into which the sipe opens, by virtue of the greater local flexibility of the tread that is conferred by said sipe.

According to the second and third essential features of the invention, respectively, the first point of intersection of the sipe with an external cavity of the first complex cut is positioned in the vicinity of the leading end of said external cavity, and the second point of intersection of the sipe with the closest external cavity of the second complex cut is positioned in the vicinity of the trailing end of said external cavity.

This respective positioning of the ends of the sipe with respect to each external cavity into which it opens makes it possible, by virtue of the offset between the respective external cavities of the two adjacent complex cuts being optimized, both to limit the generation of noise by the sipe and to limit the occurrence of uneven wearing at the external cavities.

Advantageously, the sipe having, with respect to the direction of the plane bisecting the external cavity, a mean inclination angle, defined as the gradient of the straight line passing through the two points of intersection of the sipe with the external cavities, the mean inclination angle is at least equal to 10° and at most equal to 45°, preferably at least equal to 20° and at most equal to 35°. A mean inclination angle of the sipe, contained within this range, contributes to limiting the noise generated by the sipe.

Also advantageously, the sipe having, with respect to the direction of the plane bisecting each external cavity, an angle of incidence at the point of intersection, defined as the gradient of the straight line tangent to the sipe at the point of intersection, the angle of incidence is at least most equal to the mean angle of inclination. This angle of incidence characterizes the position of the mean line of the sipe with respect to the edge of the external cavity, and consequently defines the angular sector of the portion of material delimited by the sipe and the edge of the external cavity. Thus, the smaller this angle of incidence, the less the angular sector of the portion of material forms a sharp angle, thereby reducing the risk of local chunking at the edge of an external cavity, in the vicinity of its intersection with the sipe.

Also advantageously, each sipe has a constant height. A constant height avoids any geometric singularity at the base of the sipe, such as a discontinuity or a bridge, likely to be the site of a stress concentration that may cause local cracking at the base of the sipe and, consequently, local chunking.

Advantageously, each sipe has a height at least equal to the height of the narrowing. Thus, as the tire wears down, the sipe remains visible at the tread surface at least until the internal cavities appear at the tread surface, thereby ensuring the durability of the grip of the tread as the tire wears down.

Advantageously, each external cavity has a bottom radius at least equal to 2 mm. As shown above, the greater the bottom radius, the higher the resistance to cracking.

Advantageously, each internal cavity has a width at least equal to 5 mm. A sufficiently wide cavity allows a flow for storing and/or evacuating water that is favourable to satisfactory grip on wet ground, at an advanced level of wear corresponding to the presence of the internal cavities at the tread surface.

Also advantageously, each internal cavity has a height at least equal to 5 mm. As above, a sufficiently high cavity allows a flow for storing and/or evacuating water that is favourable to satisfactory grip on wet ground, at an advanced level of wear corresponding to the presence of the internal cavities at the tread surface.

Advantageously, each internal cavity has a bottom radius at least equal to 2 mm. As in the case of an external cavity, the greater the bottom radius, the higher the resistance to cracking. A large bottom radius is easily conceivable for an internal cavity since this usually has a sufficient width.

According to a preferred embodiment, all the cuts are complex cuts, this making it possible to optimize the compromise between wear, grip and rolling resistance.

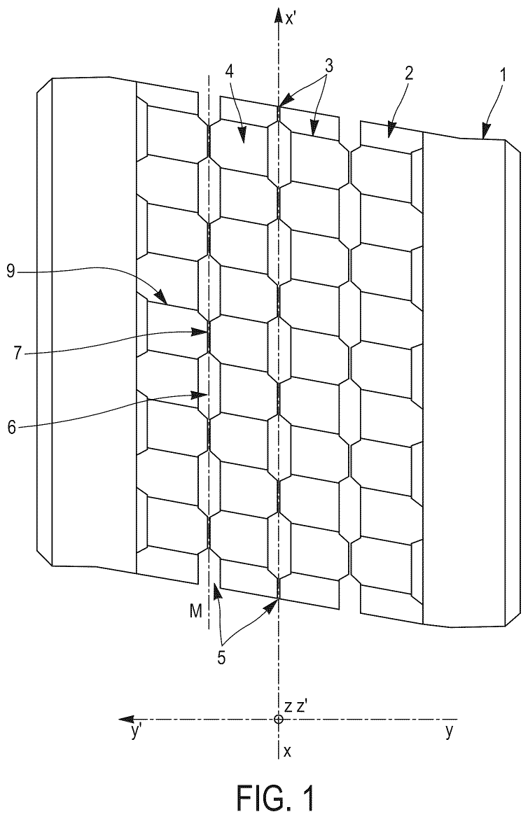

The features of the invention are illustrated in the schematic FIGS. 1 to 6, which are not shown to scale:

FIG. 1: Overall top view of a tread according to a first embodiment of the invention, intended for use on a steering axle,

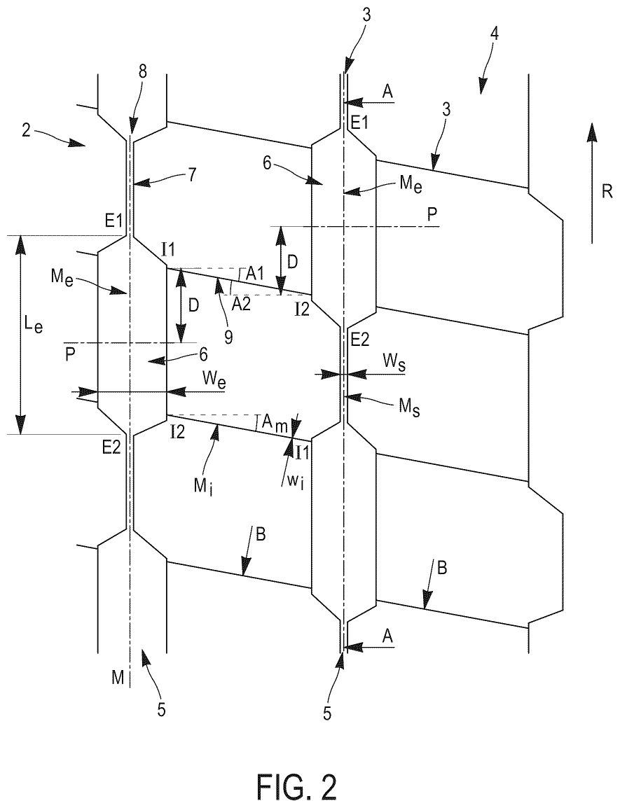

FIG. 2: Partial top view of a tread according to the first embodiment of the invention,

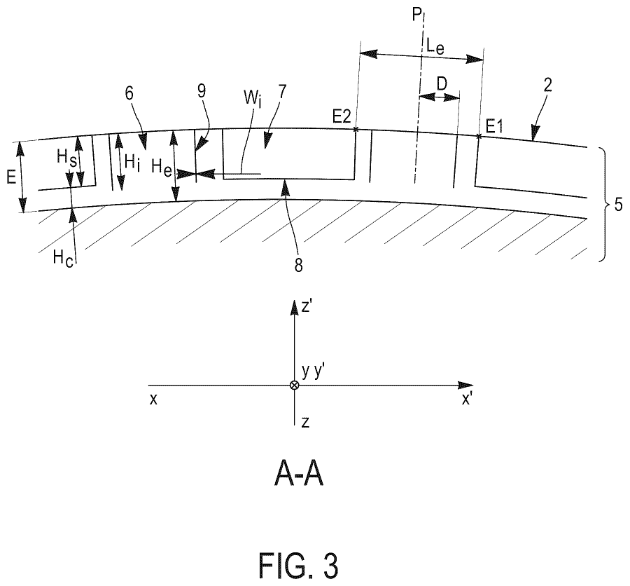

FIG. 3: View in circumferential section of a portion of a complex cut of a tread according to the first embodiment of the invention,

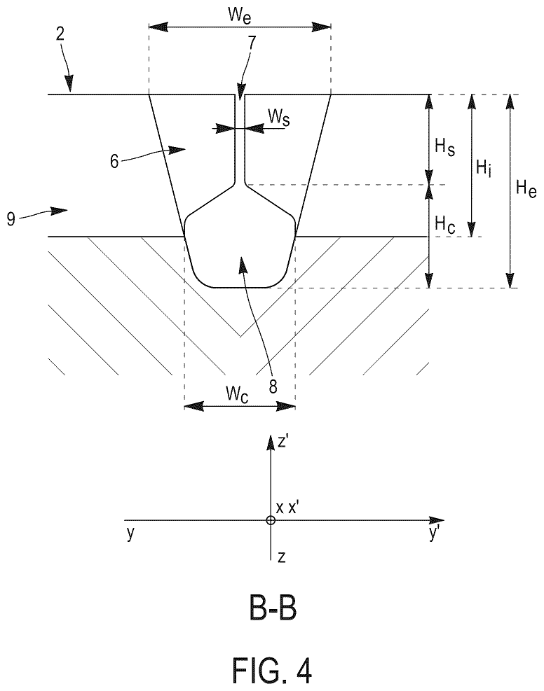

FIG. 4: View in cross section along a sipe opening into a complex cut of a tread according to the first embodiment of the invention,

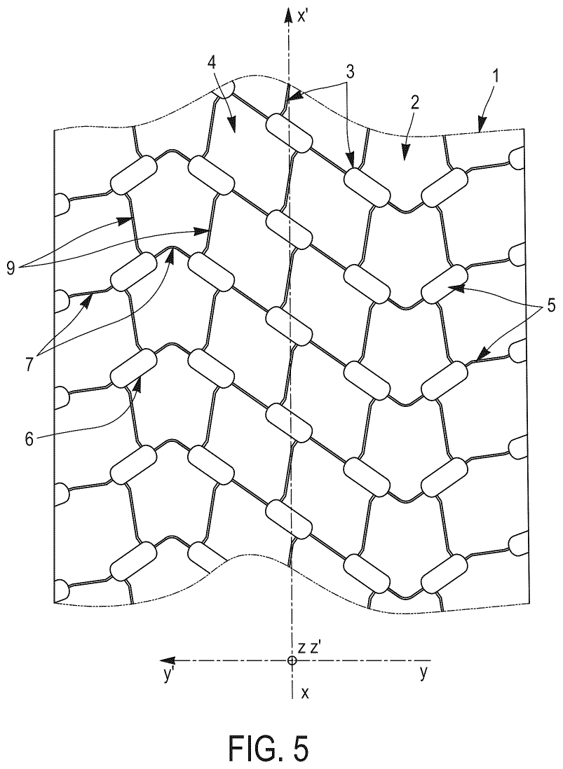

FIG. 5: Overall top view of a tread according to a second embodiment of the invention, intended for use on a driven axle,

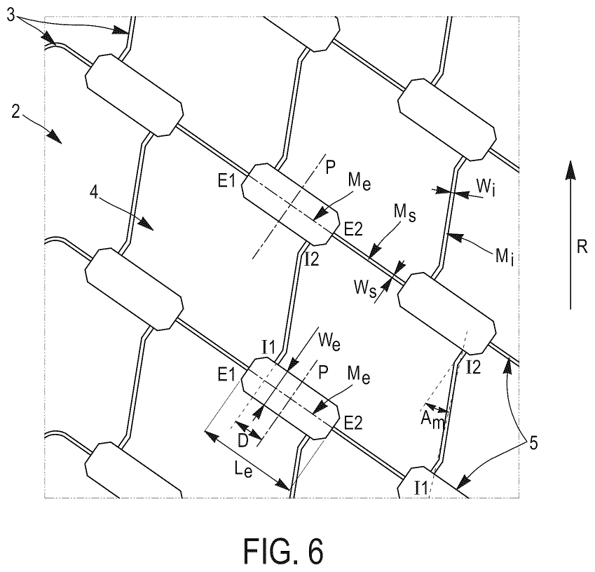

FIG. 6: Partial top view of a tread according to the second embodiment of the invention.

FIG. 1 is an overall top view of a tread 1 according to a first embodiment of the invention, intended for use on a steering axle of a heavy-duty vehicle. The tread 1, intended to come into contact with the ground via a tread surface 2, comprises cuts 3 delimiting raised elements 4. The tread 1 has a thickness E, measured perpendicularly to the tread surface 2, that is equal to the depth of the deepest cut 3, this thickness E being shown in FIG. 3. The tread 1, shown in FIG. 1, comprises five complex cuts 5 that are adjacent in pairs and each comprise, when the tire is new, an alternation of external cavities 6 and narrowings 7, and each have a mean line M extending along the circumferential direction XX′ of the tire. Each narrowing 7 of every complex cut 5 is continued radially inwards by an internal cavity 8, shown in FIGS. 3 and 4. Each external cavity 6 of a given complex cut 5 is connected to two external cavities 6 of any complex cut 5 adjacent to said complex cut 5 by two sipes 9.

The first embodiment of the invention is described in detail by FIGS. 2, 3 and 4. FIG. 2 is a partial top view of a tread according to the first embodiment of the invention described above. FIG. 3 is a view in circumferential section A-A of a portion of a complex cut of a tread according to the first embodiment of the invention. FIG. 4 is a view in cross section B-B along a sipe opening into a complex cut of a tread according to the first embodiment of the invention. Each external cavity 6 has a length Le, measured at the tread surface 2, between a leading end E1, intended to come into contact with the ground first, in the running direction R of the tire, and a trailing end E2, intended to come into contact with the ground last. The leading end E1 and trailing end E2 are positioned on a mean line Me of the external cavity 6. The external cavity 6 has a width We, measured perpendicularly to the mean line Me of the external cavity 6, the maximum value of which is at least equal to 6 mm, and has a height He, measured perpendicularly to the tread surface 2. Each narrowing 7 has a width Ws, measured perpendicularly to a mean line Ms of the narrowing 7, at most equal to the width We of the external cavity 6 and at most equal to 2 mm, and has a height Hs, measured perpendicularly to the tread surface 2. The narrowing 7 is continued radially inwards by an internal cavity 8, having a width Wc, measured perpendicularly to a mean line of the internal cavity, and having a height Hc, measured perpendicularly to the tread surface 2. Every sipe 9 extends from a first point of intersection I1 with an external cavity 6 of a first complex cut 5 to a second point of intersection I2 with the closest external cavity 6 of a second complex cut 5 adjacent to the first complex cut 5. The sipe 9 has a width Wi, measured perpendicularly to a mean line Mi of the sipe 9, at most equal to 2 mm, and has a height Hi, measured perpendicularly to the tread surface 2. According to a first feature of the invention, the distance D between each point of intersection (I1, I2) of the sipe 9 with each external cavity 6 and a plane P bisecting the external cavity 6, perpendicular to the mean line Me of the external cavity 6 and equidistant from the leading end E1 and trailing end E2 of the external cavity 6, is at least equal to 25% and at most equal to 50% of the length Le of the external cavity 6. According to a second feature of the invention, the first point of intersection I1 of the sipe 9 with an external cavity 6 of the first complex cut 5 is positioned in the vicinity of the leading end E1 of said external cavity 6. According to a second feature of the invention, the second point of intersection I2 of the sipe 9 with the closest external cavity 6 of the second complex cut 5 is positioned in the vicinity of the trailing end E2 of said external cavity 6. As described in FIG. 2, the sipe 9 has, with respect to the direction of the plane P bisecting the external cavity 6, a mean inclination angle Am, defined as the gradient of the straight line passing through the two points of intersection (I1, I2) of the sipe with the external cavities 6. Advantageously, the mean inclination angle Am is at least equal to 10° and at most equal to 45°. As also described in FIG. 2, the sipe 9 has, with respect to the direction of the plane P bisecting each external cavity 6, an angle of incidence (A1, A2) at the point of intersection (I1, I2), defined as the gradient of the straight line tangent to the sipe 9 at the point of intersection (I1, I2). Also advantageously, the angle of incidence (A1, A2) is at least most equal to the mean angle of inclination Am. In the particular case shown in FIG. 2, the angles Am, A1 and A2 are equal.

The subject of a second embodiment of the invention is a tread 1 of a tire, which is intended to be fitted on a driven axle of a heavy-duty vehicle, and is described in FIGS. 5 and 6. FIG. 5 is an overall top view of a tread according to a second embodiment of the invention, intended for use on a driven axle of a heavy-duty vehicle. FIG. 6 is a partial top view of a tread according to the second embodiment of the invention. The above-described references remain valid in the present case. This second embodiment of the invention differs from the first by way of complex cuts that each have a mean line forming a broken line and having a orientation that is generally transverse with respect to the running direction of the tire.

The inventors have more particularly studied this invention for a tire for a heavy-duty vehicle of size 315/70 R 22.5 for use on a steering axle, according to a first embodiment of the invention I1, and 295/80 R 22.5 for use on a driven axle, according to a second embodiment of the invention I2.

Table 1 below shows the characteristics of the tread which was tested:

TABLE 1

| Characteristics | I1 | | I2 | | Comments |
|---|---|---|---|---|---|
| Thickness E of tread 1 | 15 | mm | 20.5 | mm | |
| Maximum width We | 13.7 mm or | | 12 | mm | At least equal |
| of external cavity 6 | 7.2 mm | | | | to 6 mm |
| Length Le of external | 39 | mm | 30 | mm | |
| cavity 6 | | | | | |
| Height He of external | 15 | mm | 20.5 | mm | |
| cavity 6 | | | | | |
| Width Ws of narrowing 7 | 0.6 | mm | 0.4 | mm | At most equal |
| | | | | | to 2 mm |
| Height Hs of narrowing 7 | 5.5 | mm | 11.5 | mm | |
| Width Lc of internal | 8.7 mm or | | 6.5 | mm | At least equal |
| cavity 8 | 5.2 mm | | | | to 5 mm |
| Height Hc of internal | 9.5 | mm | 9 | mm | At least equal |
| cavity 8 | | | | | to 5 mm |
| Width Wi of sipe 9 | 0.4 | mm | 0.8 | mm | At most equal |
| | | | | | to 2 mm |
| Height Hi of sipe 9 | 11 mm or | | 18.5 | mm | Hi at least |
| | 8 mm | | | | equal to Hs |
| Distance D between a point | 13.5 | mm | 10 | mm | |

| | | | |
|---|---|---|---|
| of intersection (I1, I2) of | | | |
| the sipe 9 with an external | | | |
| cavity 6 and the plane P | | | |
| bisecting the external | | | |
| cavity 6 | | | |
| Ratio D/Le | 35% | 33% | Between 25% |
| | | | and 50% |
| Angle of inclination Am of | 11° | 35° | Between 10° |
| the sipe 9 with respect to | | | and 45° |
| the plane P bisecting the | | | |
| external cavity 6 | | | |
| Angle of incidence (A1, | 11° | 0° | At most equal |
| A2) of the sipe 9, at the | | | to Am |
| point of intersection (I1, | | | |
| I2), with respect to the | | | |
| plane P bisecting the | | | |
| external cavity 6 | | | |

Running tests, carried out on the above-described exemplary embodiments, have shown that treads, according to the invention, designed for use on a steering axle or on a driven axle of a heavy-duty vehicle, exhibit an advantageous compromise in performance 5 aspects between wear, rolling resistance and grip on wet ground, with a significant improvement in the robustness of the complex cuts combined with incident sipes both in manufacture, when the tread is being demoulded, and in use, with easier ejection of stones likely to be trapped in the external cavities.

1. A tire for a heavy-duty vehicle, comprising a tread that is intended to come into contact with the ground via a tread surface and comprises cuts delimiting raised elements,
the tread having a thickness (E), measured perpendicularly to the tread surface, that is equal to the depth of the deepest cut,
the tread comprising at least two adjacent complex cuts, each comprising, when the tire is new, an alternation of external cavities and narrowings,
each external cavity having a length (Le), measured at the tread surface, between a leading end (E1), intended to come into contact with the ground first, in the running direction (R) of the tire, and a trailing end (E2), intended to come into contact with the ground last, the leading end (E1) and trailing end (E2) being positioned on a mean line (Me) of the external cavity,
the external cavity having a width (We), measured perpendicularly to the mean line (De) of the external cavity, the maximum value of which is at least equal to 6 mm, and having a height (He), measured perpendicularly to the tread surface,
each narrowing having a width (Ws), measured perpendicularly to a mean line (Ms) of the narrowing, at most equal to the width (We) of the external cavity and at most equal to 2 mm, and having a height (Hs), measured perpendicularly to the tread surface,
the narrowing being continued radially inwards by an internal cavity, having a width (Wc), measured perpendicularly to a mean line of the internal cavity, and having a height (Hc), measured perpendicularly to the tread surface,
at least one sipe, extending from a first point of intersection (I1) with an external cavity of a first complex cut to a second point of intersection (I2) with the closest external cavity of a second complex cut adjacent to the first complex cut,
the sipe having a width (Wi), measured perpendicularly to a mean line (Mi) of the sipe, at most equal to 2 mm, and having a height (Hi), measured perpendicularly to the tread surface (2),
wherein the distance (D) between each point of intersection (I1, I2) of the sipe with each external cavity and a plane (P) bisecting the external cavity, perpendicular to the mean line (Me) of the external cavity- and equidistant from the leading end (E1) and trailing end (E2) of the external cavity, is at least equal to 25% and at most equal to 50% of the length (Le) of the external cavity, the first point of intersection (I1) of the sipe with an external cavity of the first complex cut is positioned in the vicinity of the leading end (E1) of said external cavity, and the second point of intersection (I2) of the sipe with the closest external cavity of the second complex cut is positioned in the vicinity of the trailing end (E2) of said external cavity.

2. The tire according to claim 1, wherein the sipe has, with respect to the direction of the plane (P) bisecting the external cavity, a mean inclination angle (Am), defined as the gradient of the straight line passing through the two points of intersection (I1, I2) of the sipe with the external cavities, and wherein the mean inclination angle (Am) is at least equal to 10° and at most equal to 45°.

3. The tire according to claim 2, wherein the sipe (9) has, with respect to the direction of the plane (P) bisecting each external cavity-, an angle of incidence (A1, A2) at the point of intersection (I1, I2), defined as the gradient of the straight line tangent to the sipe at the point of intersection (I1, I2), and wherein the angle of incidence (A1, A2) is at least most equal to the mean angle of inclination (Am).

4. The tire according to any claim 1, wherein each sipe has a constant height (Hi).

5. The tire according to claim 1, wherein each sipe has a height (Hi) at least equal to the height (Hs) of the narrowing.

6. The tire according to claim 1, wherein each internal cavity has a width (Wc) at least equal to 5 mm.

7. The tire according to claim 1, wherein each internal cavity has a height (Hc) at least equal to 5 mm.

8. The tire according to claim 1, wherein all the cuts are complex cuts.

9. The tire according to claim 2, wherein the mean inclination angle (Am) is at least equal to 20° and at most equal to 35°.
